(19) United States
(12) Patent Application Publication
(10) Pub. No.: US 2006/0190419 A1
(43) Pub. Date: Aug. 24, 2006

(54) Video surveillance data analysis algorithms, with local and network-shared communications for facial, physical condition, and intoxication recognition, fuzzy logic intelligent camera system

(76) Inventors: Frank E. Bunn, Thornhill (CA); Richard D. Adair, Waterloo (CA)

Correspondence Address: Dr. Frank E. Bunn, 26 Church Lane, Thornhill, ON, L37 2G5, CA

(21) Appl. No.: 11/062,601

(22) Filed: Feb. 22, 2005

(51) Int. Cl. G06F 15/18

(52) U.S. Cl. 706/2

(57) ABSTRACT

This invention relates to intelligent video surveillance fuzzy logic neural networks, camera systems with local and network-shared communications for facial, physical condition and intoxication recognition. The device we reveal helps reduce underage drinking by detecting and refusing entrance or service to subjects under legal drinking age. The device we reveal can estimate attention of viewers of advertising, entertainment, displays and the like. The invention also relates to method, and Vision, Image and related-data, database-systems to reduce the volume of surveillance data through automatically recognizing and recording only occurrences of exceptions and elimination of non-events thereby achieving a reduction factor of up to 60,000. This invention permits members of the LastCall™ Network to share their databases of the facial recognition and identification of subjects recorded in the exception occurrences with participating members' databases: locally, citywide, nationally and internationally, depending upon level of sharing permission.

### CROSS-REFERENCE TO RELATED APPLICATIONS

Bunn et al, U.S. patent application Ser. No. 10/626,888 (filed Jul. 25, 2003), “Voice, Lip-reading, Face and Emotion Stress Analysis, Fuzzy Logic Intelligent Camera System”

Bunn et al, U.S. patent application (filed Dec. 6, 2004, number not yet assigned), “Data Analysis Algorithms for a Voice, Lip-reading, Face, Emotion, Intoxication Impairment and Violent Behavior Stress Analysis, Fuzzy Logic Intelligent Camera System.”

### STATEMENT REGARDING FEDERALLY SPONSORED RESEARCH OR DEVELOPMENT

Not Applicable

### REFERENCE TO SEQUENTIAL LISTING, A TABLE, OR A COMPUTER PROGRAM LISTING COMPACT DISK APPENDIX

Not Applicable

### BACKGROUND OF INVENTION

Video surveillance for security of things, places, and people has long been a major area of patenting of methods, systems, techniques, and technology. Analyses of data from security video cameras for security surveillance are well known. Lemelson, in 1991 U.S. Pat. No. 5,067,012, reveals a method and system for scanning and inspecting video camera images for automated recognition of objects, and Higashimura et al, in 2002 U.S. Pat. No. 6,747,554, reveal a network surveillance unit and means for recording video security camera images which can be related to local alarm signals with methods and means for storing, viewing and distributing these data via internet WEB communications. Alexander et al, in 2005 U.S. Pat. No. 6,839,731, reveal shared network methods and means for sharing information from databases via internet WEB communications with secure access implementation of ID cards and PIN numbers, video data surveillance, voice recognition and such high security systems to maintain secure information communications.

The well-known video surveillance technology for recognition of objects, such as revealed in the Lemelson 1991 U.S. Pat. No. 5,067,012 for detecting objects, has been applied to detecting and recognizing specific persons and tracking their movement by head appearance and movement of subjects as revealed in the Darrell et al 2002 U.S. Pat. No. 6,445,810. Refining observations to a singular subject, video surveillance methods have been applied to the actual movement of body parts of a subject, such as tracking eye movement in the Strachan 1999 U.S. Pat. No. 5,980,041 by reflecting infrared light from a hologram off the retina of the subject and using triangulation of the reflected light for development of physiological measurement tools for eye focus and movement, and in the Harman 2002 U.S. Pat. No. 6,459,446 by reflecting infrared light off the cornea of the subject and using multiple cameras to track eye movement for development of viewing technology for 3-D video.

Significantly advancing the video surveillance technology, Bunn et al, in 2003 U.S. patent application Ser. No. 10/626,888, teach a voice, lip-reading, face and emotion stress fuzzy logic intelligent camera system which analyzes digital video data to automatically detect stress on people, animals or things for the purpose of recognizing facial or body appearance or movement or speech which could indicate stress on, or danger or a threat or potential of danger or threat to or from persons, animals, actions, activities, or things. Bunn et al, in 2003 U.S. patent application Ser. No. 10/626,888, contemplate including detecting and estimating intoxication and impairment levels by alcohol or drugs of subjects observed and linking this detection to identification of the observed subject for facial and voice recognition as well as identification by ID card, photo ID and the like. Bunn et al, in 2004 U.S. patent application (Filed Dec. 6, 2004, number not yet assigned), further teach the fuzzy logic algorithms that permit detection and interpretation of the features describing the facial or body or speech or appearance or movement noted in U.S. Ser. No. 10/626,888.

The preferred embodiment of the present invention is focused on the integration of the video surveillance technology prior art whether referred to herein or otherwise for the purpose of detection of intoxication, drunken and impaired behavior including the identification of subjects and the possible prevention of underage drinking in a localized establishment or place by means of a system that we call SoberCam™, and the sharing of such information throughout a communications network of central database systems and participating networked groups, systems or agencies alerting security personnel, systems and agencies for appropriate response in a distributed system we call LastCall™ Network.

A significant problem exists with most of these conventional embodiments of video surveillance and security types of systems in that they acquire very large and unwieldy volumes of data. Surveillance systems in the prior art view, observe, record and process many details of the images from video cameras and systems but do not deal well with the control and limitation of the data contained in the video data stream whether in analogue or digital format. With the modern state of the art, digital video recording (DVR) systems and high-speed, high-resolution cameras can generate 1.5 terabytes of data in 15 minutes.

This invention deals with the ways and means for overcoming this digital glut.

### BRIEF SUMMARY OF THE INVENTION

A preferred embodiment of the invention herein combines software, neural logic, fuzzy logic, neural networks and artificial intelligence to monitor, analyze and select data bits that occur when a pre-determined algorithm or electronic signature is activated. The algorithm acts as a switch that signals the system to discard irrelevant data while saving selected items. In practice, 99.9983% of the usual video surveillance data will be discarded and only 0.0017% retained for security personnel attention. One method of achieving this reduction in “real time” is to have the system buffering data for a short time while analyzing it and upon being activated, the system would record the buffer data incoming data until again activated to stop recording. The buffer would need to be large and the system processing speed fast enough so that non of the desired data are lost.

In another preferred embodiment of the invention, the algorithm selects and retains images of an individual subject only when there are legally valid grounds for doing so on the basis of just cause. All other images can be discarded.

In another preferred embodiment of the invention, the algorithm and image assessment system can use the monitoring and intelligence capabilities of the software to adjust to ever-increasing speeds and resolution improvements in the video camera systems thereby maintaining the minimum data storage levels as the camera technology advances.

In effect, our intelligent camera acts as a video surveillance data analyzer for 99.9% of the time and as a conventional surveillance camera system storing images for 0.1% of the time. In a preferred embodiment of the invention, the algorithms could be fine-tuned to a specific surveillance application and scene being observed, such that the analyzer could remove 99.9983% of the images and thus retain only 0.0017% for a reduction of data storage of nearly a factor of 60,0000.

Bunn et al, patent application U.S. Ser. No. 10/626,888 filed Jul. 25, 2003, teaches algorithms such as staggering, drug-taking and dealing, violence, threatening movements, throwing objects and related anti-social activities that can trigger intelligent camera systems to automatically recognize these occurrences and notify the appropriate security personnel. These video data recordings are of sufficient resolution and frame speed that can be matched by the existing DVR data acquisition and storage and image database management systems of the day.

A preferred embodiment of the invention goes further and uses high-resolution, high-speed video camera systems with different algorithms to measure fine resolution characteristics of observed subjects such as, but not limited to, measuring pupil dilation of the eyes, sweating, blushing, and other bio-behavioral aspects at the onset, and notes changes in these aspects thereafter and calibrates them to levels of impairment, intoxication and behavioral changes. In this application, the subjects being observed in effect provide their own basic database standards against which to measure change. This we call the SoberCam™ application.

The SoberCam™ camera system envisioned in a preferred embodiment of the invention will also use algorithms to scan at high-resolution and high-speed video surveillance large venues such as entertainment arenas, sporting fields of play and the like for which the system and algorithms can establish virtual barriers to detect incursions into selected restricted areas. Camera resolution is such as to detect a person moving from higher levels in the venue to close proximity to the entertainment or playing surfaces or areas for which algorithms will detect and notice and command the system to monitor and record this movement for later analyses or identification. Potentially rowdy spectators can also be similarly identified and noted and images recorded. In a preferred embodiment of the invention, subsequent escalation of activities by the observed subjects can be further analyzed by the algorithms to detect hotspots of potentially threatening or violent behavior and the system can alert security personnel for appropriate action to be taken.

In a preferred embodiment of the invention, the SoberCam™ observations and database-stored imagery can be recalled for the venue in question as an information source of video evidence to support legal actions as needed.

In a preferred embodiment of the invention, the information stored in the system's databases of images, video data and algorithm results can be shared with other groups, entertainment and sporting venues, related clubs, bars and the like as a pre-emptive warning of local, nearby neighborhood, inter-city, nation-wide or international potential threat, disruption or problem whether at the same time, other times or other sites. This sharing of such information we call LastCall™ Network.

In a preferred embodiment of the invention, the occurrence for example of intoxication by an observed subject at say nightclub A can trigger storage of video data and by using facial recognition of subjects entering the nightclub A at later times and comparing these to the recorded database can permit the system to recognize previous trouble makers and alert security to take appropriate action. This would be LastCall™ Network operating on a restricted local basis.

In a preferred embodiment of the invention to illustrate an example, in which the information from the above occurrence at nightclub A is shared with Nightclub B and Nightclub C in the neighborhood this would be LastCall™ Network operating on the citywide basis. A further example is if the above occurrence happened at a sporting venue in City A and is shared with a sporting venue in City B this would be LastCall™ Network that could be inter-city or nation-wide or international depending on where they are located.

In a preferred embodiment of the invention, SoberCam™ could be used to prevent underage drinking in which the system would use technology of ID cards such as but not limited to student, health, driver's license, social security, credit and such like cards, scanning of both magnetic strip or smart card information and imbedded picture ID. The system would use facial recognition to assess if the subject being observed on site is the same as the ID picture and information and whether the subject appears to be under drinking age. Features such as lack of wrinkles and non-existence of beard, and balding and sagging neck skin or frequency and timber of voice are not perfect by can be indicators of relative age. If the analysis algorithms suspect underage, the system can inform security personnel to investigate and if appropriate to take action to deny entrance to a drinking establishment or area. This information could be shared via the LastCall™ Network to participating groups, drinking establishments and the like, thereby further assisting the prevention of underage drinking.

In another preferred embodiment of the invention, utilizing wide-angle and zooming narrow angle video camera technology with high-resolution and high-speed capabilities the SoberCam™ system utilizing illumination, such as but not limited to, infrared directed from the camera location towards subjects could view the reflected infrared light from the eyes of the subjects such as at a sporting event arena to detect the number of subjects looking specifically in the direction of the camera. This would be similar to the “animal in the headlights” example of a cat looking towards your oncoming vehicle at night, where light from the headlights will reflect off the animal's retina directly back to the vehicle such that the driver may see only the two bright spots of light reflecting from the cat's eyes. Algorithms in the SoberCam™ system could simply count the number of bright spots and divide by 2 to get a good approximation of the number of subjects looking directly at the camera and light source.

This retina reflection of light application is not strictly tracking eye movement of the subjects but rather detecting at any instant, the number of subjects looking in a specific direction. If the camera and light source are located near where an advertisement such as on an illuminated sign or billboard or electronic display such as a “JumboTron” the system in this embodiment of the invention could measure the effectiveness of what is being displayed such as an advertisement. In effect the system algorithms are measuring crowd response to displayed images or messages, which could collect statistics that could be interpreted to assess effectiveness of the display, or the message or advertisement. If the system is observing subjects entering a venue and the system detects the subjects watching a billboard and thus not watching where they are walking, say down stairways or aisles, this could provide evidence of the subject's responsibility should an accident such as tripping occur.

In another preferred embodiment of the invention, the collection of video data over time provides the SoberCam™ system with information from which to derive statistically important conclusions. Effectiveness of advertising noted above is one such conclusion. Changes in the actions of subjects over time can permit statistical conclusion of the onset of intoxication or impairment of the observed subjects, or the escalation of violence, or the occurrence of a health condition such as seizure or heart attack.

Sharing of information in databases via the LastCall™ Network application need not be limited to those data selected by the SoberCam™ intelligent video surveillance camera system but can incorporate related databases such as personal identification information, legal or criminal activities, actions or convictions, health and drug or alcohol information, suspected terrorist activities and the like. Sharing of all such information permits the algorithms to detect problems or potential problems quickly, automatically allowing the system to notify the authorities and security personnel to take appropriate action.

### BRIEF DESCRIPTION OF THE SEVERAL VIEWS OF THE DRAWING

FIG. 1 is a schematic diagram of an Intelligent surveillance Camera System means for providing data used by the algorithms according to an embodiment of the present invention including a camera means with its incorporated local controller and incorporated algorithms and fuzzy logic and related databases, the optional central facility with incorporated central controller incorporating the algorithms and fuzzy logic and related databases, and the wireless and land line linkages.

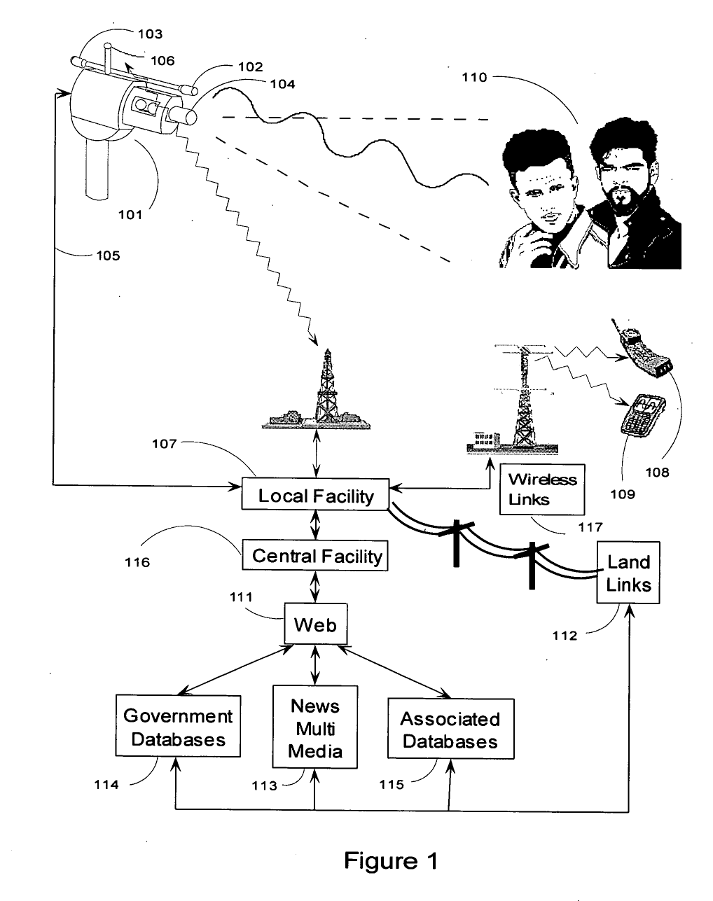

FIG. 2 is a block diagram focusing on the Exceptions Data Engine fuzzy logic processor employing data reduction algorithms of this invention for reducing data recording to specific occurrences or exceptions in the data from the observation sensors, input-output devices, camera means with integrated local controller and display I/O systems linked to database storage, related databases and to security/decision-makers and reporting.

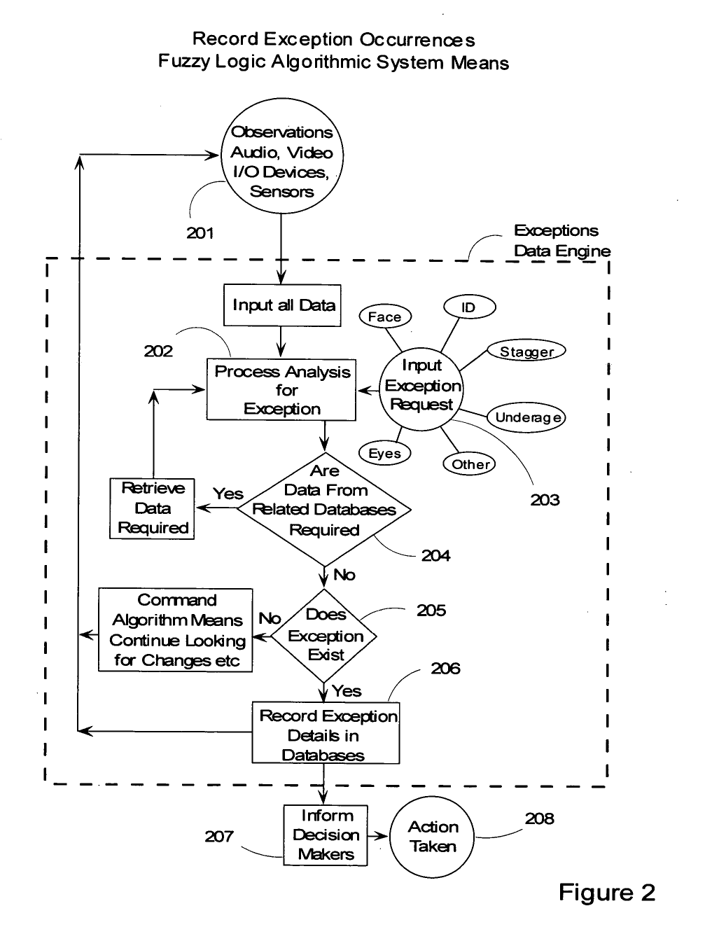

FIG. 3 is a schematic diagram of the SoberCam™ local process flow from observations passing through the Exceptions Data Engine to the SoberCam™ Intelligence Engine incorporating the fuzzy logic processor and analysis system means for interpretation of the exception occurrence of an action, motion, appearance, impairment, stress or threat of an observed, identified subject by the analysis of exception occurrence data from the intelligent surveillance camera system means observations and related database information and linked to security/decision-makers and reporting according to an embodiment of the present invention.

FIG. 4 is a schematic diagram of the LastCall™ Network shared process and information flow from observations at approved participating agencies, clubs and venues each incorporating the Exceptions Data Engine for data reduction to exceptions data which is passed through the shared LastCall™ communications network to the Central Facility for processing by the SoberCam™ Intelligence Engine for storage and retrieval using associated databases and fuzzy logic interpretation, classification of occurrence, previous occurrences, subject identification and links to security/decision-makers and reporting.

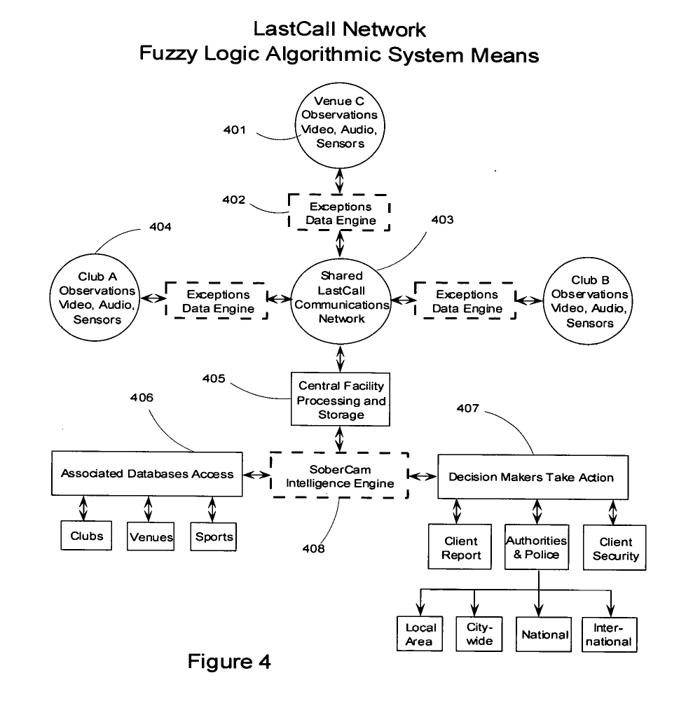

### DETAILED DESCRIPTION OF THE INVENTION

The descriptions that follow are provided so as to enable any person skilled in the art to make and use the invention, and sets forth some modes presently contemplated by the inventors of carrying out their invention. Various modifications, however, will remain readily apparent to those skilled in the art, since the generic principles of the present invention have been defined herein.

Data for processing by the algorithms revealed in this invention are obtained from observations by an intelligent Camera System means incorporating the use of, but not limited to, sensors, input-output devices such as a surveillance camera means with incorporated local controller, 101, with associated illumination means, 102, and listening audio means, 103, and video means, 104, functions and full pan, tilt and zoom computer-controlled motion for monitoring of a given scene, situation, place, thing, persons or environment. A unique aspect of the Camera System means is the incorporation of the new technologies of high-resolution, low noise-level, low light-level, high-speed digital camera systems which permits the algorithms to perform in the real-world environment of nightclubs, bars and large venue arenas as well as they perform in the laboratory monochromatic calibration environments. It is these modern enabling technologies that give rise to the development of the algorithmic means of this patent.

In a preferred embodiment, the algorithms of this invention could be analyzing movements of a person or persons and their activity, 110, with a plurality of sensors and input-output means such as but not limited to audio and video, the data from which can be communicated by wired, 105, or wireless, 106, to a local facility, 107, so that the intelligent analysis means, located at the local, 107, or central, 116 facilitiy employing the algorithms of this patent can interpret those person or persons and/or activities, their conditions or drug or alcohol induced impairments and possibility for potential threat from the subject's appearance, movements and actions. Observations of subjects and identification credentials such as magnetic or intelligent ID cards, driver's license or photo ID, heath ID can also permit identification of the subject by using but not limited to algorithmic comparisons to earlier observation databases of audio, visual and speech and text information to which the facilities are connected via the Internet WEB, 111, or by hardwired land or telephonic, 112, or wireless links, 117 to other News MultiMedia, 113, Government, 114 and Associated, 115 databases. Analyses results can be sent out through the WEB 111, or land links, 112, or by wireless, 117, to computers and hand held devices, 109 or to the cellular network and cell phone units, 108.

A unique aspect of the fuzzy logic algorithmic Exceptions Data Engine means of this invention is its ability to learn from the data collected from these observations, 201, and from data in and collected for the comparison databases. The process of analyzing these data to determine an exception, 202, creates the definable occurrences of exceptions that can be used to eliminate unwanted data, 203, 204, and 205. Depending upon selectable criteria that define the exceptions, 203, the elimination of data at any give time could range from 100%, no recording, through to 0% with recording of all observations. A typical embodiment of this invention could result in elimination of 99.9983% of the observations, reducing database information storage, 206, by a factor of nearly 60,000 while efficiently citing and reporting exceptions to decision makers, 207, permitting appropriate action to be taken, 208.

For example, if the subject under observation is a young person the analyses, 202, with face recognition could compare photo ID and general facial appearance, 203, to determine that the person may be underage. If available, related databases could be queried, 204, to see if birth date information such as given on a driver's license could confirm the subject's age. In any event the Exceptions Data Engine would have queried, 205, and detected the occurrence of the exception and stored that occurrence in the exceptions databas, 206, that the subject may be underage and informed the decision makers, 207, to take appropriate action, 208, such as to deny that person access to a drinking establishment, area or venue.

In a preferred embodiment of this invention, the observations can include but are not limited to observing from a few to large crowds of subjects who have been illuminated by a lighting means, 102, located near the intelligent camera means, 101, from which data vision analyses for an exception request to the Eyes analysis, 203, by the Exceptions Data Engine could detect the number of subjects within view, who are looking in the camera direction. This analysis could employ detection of the reflection from the retinas of the subjects' eyes that if looking in the direction of the camera and the light source located there, would appear as bright spots. In darkened locations such as sports or entertainment venues, using infrared illumination, which is not visible to the subjects, would not be invasive and would permit the subjects' pupils to remain more open and hence increase the reflected light resulting in brighter and more easily detected reflections. With sufficient camera speed and resolution technology, the individual eyes of each subject would be resolved to create two such bright spots and the analyses could determine how many subjects were looking towards the camera and light source. Such information could be recorded as an exception, 206 and passed to inform decision makers, 207, for use to measure response of subjects to whatever was at the location of the camera such as advertising, video displays, security information, entertainment and such like.

These database means and facilities, whether incorporated into the camera means or located elsewhere, can include local and remote databases including but not limited to: the Multi-Media, 113, such as print including newspapers, radio and TV; the Government, 114, such as criminal activity/conviction, or incarceration, or driver's license identification, or terrorist activity; and the Associated data systems, 115, such as medical/mental health, or education, and the like. Health information, in particular could be critical in understanding the actions, emotions and motions of persons to recognize the differences between drunkenness, heart attack, diabetic coma, epileptic seizure and the like. These databases as part of the Camera System means can be linked via the WEB, hardwired, telephony or wireless means for access, analyses by the algorithmic means revealed in this patent.

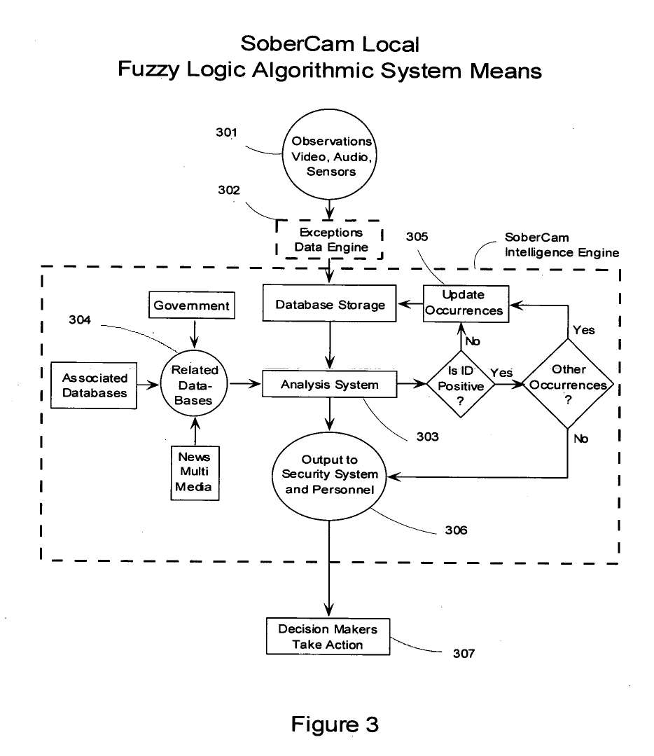

In a preferred embodiment of the invention, the SoberCam™ Local fuzzy logic algorithm system means, learning by the Camera System means can result from a plurality of fuzzy logic algorithmic analyses incorporated into the SoberCam™ Intelligence Engine illustrated in FIG. 3. Observations, 301, reduced to exception occurrences by the Exceptions Data Engine, 302, pass these exception occurrences data to the SoberCam™ Intelligence Engine for storage and analyses with the fuzzy logic processor, 303, including but not limited to making comparisons with stored, 304, previous exceptions data such as faces of persons, or audio data such as speech, or actions, or history, or medical problems, or outstanding legal charges.

In a preferred embodiment of the invention, for the above example of a subject who appears underage, the related databases, 304, may contain a driver's license information and photo ID that could confirm the Exceptions Data Engine facial recognition analysis of the subject and SoberCam™ Intelligence Engine could identify that the subject indeed was younger than legal drinking age. In this example, related database searches, 304, in a health database could indicate the subject has a serious heart condition and in a legal database could indicate there is an outstanding arrest warrant for the subject. The analysis system means, 303, so learns and updates the occurrences databases, 305, that this person currently under surveillance observation is underage, has an outstanding arrest warrant and the fuzzy logic algorithmic system means reports to the security systems and personnel, 306. In this example the decision makers, 307, would be advised to deny the person access to drinking areas, venues or establishments and to immediately inform the police for appropriate action. Prevention of underage drinking is a unique aspect of this invention. Assisting police is another unique aspect of this invention.

The SoberCam™ Intelligence Engine includes a plurality of computer analysis techniques and technologies, software, firmware and hardware methods and designs including but not limited to recording and storage and retrieval of data, video pattern recognition, facial recognition, body action recognition, stress analysis of facial appearance and movement, stress analysis of body appearance and movement, emotional condition stress analysis from facial and/or speech and/or body action, surrounding environment condition assessment, voice stress analysis, voice recognition, voice speech recognition to text, lip reading recognition of speech and conversion to text, deep extraction of information and meaning from text or multi-media information, identification ID and photo ID input-output data analyses and the like.

Many of these techniques and technologies have been noted in the background to this invention, but what is unique in this invention is that we reveal an Exceptions Data Engine means for massive reduction of stored data observations and the SoberCam™ Intelligence Engine automated learning and decision analysis for the detection and understanding of a threat or potential threat or condition of or by a person or persons or animals or objects, by their actions, or their appearance, or their impairment intoxication, or their personal information and history, or any combination of these.

In a preferred embodiment of this invention, we reveal a method and means to significantly utilize the above Exceptions Data Engine and SoberCam™ Intelligence Engine processing and analyses of these video, audio, input-output and sensor data through a centralized Vision storage, retrieval and analysis facility. Unique to this embodiment of the invention, this facility provides the capability of networked sharing of Image, Vision and related data Information directed to fighting underage drinking, preventing drunk driving, and preventing the escalation of threatening actions or situations. We call this the LastCall™ Network of Fuzzy Logic Algorithmic System Means.

The LastCall™ Network allows permitted members of the network such as Venue C, 401, Club B, 409, and Club C, 404, each reducing data via their individual Exceptions Data Engine, 402, to access the Shared LastCall™ Communications Network, 403, to exchange data and information with a Central Processing and Storage Facility, 405. The central processing and storage facility operating the SoberCam™ Intelligence Engine, 408, can store, analyze, interpret and categorize these data and analyses results in the associated databases, 406, as described above, and report to the decision makers to take appropriate action, 407.

Unique to the LastCall™ Network is its ability to permit access to the network members approved at various levels, to access results and exception occurrences of local area, citywide, national, or international information depending on their level of access permission. This increases the effectiveness and utility of the exceptions data and extends the reach of the LastCall™ Network Fuzzy Logic Algorithmic System Means from the local to the citywide to the National and to the International scene.

In a preferred embodiment of the invention, the participating members of the Network could be automatically updated with recent exception occurrences from the local area, citywide, national or international databases. The members could have this information sent to their local systems, and could have it recorded, displayed, noted to wireless cellular phones or personal data assistants (PDA's) and the like. In the above example of the young person who is under legal drinking age and with an outstanding arrest warrant as detected by the SoberCam™ Intelligent Engine, the person could possibly slip away from the establishment where they were detected. The person could then attempt to enter a nearby establishment also on the Network that could have already informed them to be on the lookout for the person thereby assisting the security personnel in advance. If the person appears, the Network would identify the person and collaborate to the security personnel of the problem with this person so immediate action could be taken. If the person is a security threat, wide dissemination of the information through the Network could help to prevent a national or international security threat.

We have indicated just some but not all of the examples of preferred embodiments, applications and uses of the Algorithm Analysis System means revealed in this invention that would come to mind of a person or persons skilled in the art of security systems.

1. A Fuzzy Logic Data Analysis Algorithmic System comprising:
a) a local controller, hardware, software, firmware and fuzzy logic including wireless or wired communications interface for communicating with a central controller facility;
b) a camera audio and video recording device connected to said local controller for observing and recording and communicating to said central controller;
c) a central controller with hardware, software, firmware and fuzzy logic for database storage and analyses of images and sounds from observed actions, appearances, activities, and movements of objects, animals, persons and surroundings, in general, within view and listening of the said camera device as communicated from said camera devices;
d) a central controller with hardware, software, firmware and fuzzy logic for accessing both real-time data and historic data from related databases from sources of governments, of multimedia news agencies, of associated data for the purpose of conducting analyses for assessment and detection of intoxication, impairment, encumbrance, of subjects due to alcohol, drugs or heath;
e) fuzzy logic algorithms for the purpose of analyses of video data of subjects' movement with mathematical analyses permitting comparisons of, and deviations from, calibrated standard observations of normal non-intoxicated, non-impaired and healthy subject's movement to observations of subjects' in general, to assess potential intoxication, impairment and encumbrance by drugs, alcohol or ill health;
f) an input device connected to said local controller for reading from or writing to magnetic or electronic storage data means and/or a manually entering data means for input to said local controller;
g) an output device associated with said local controller for displaying visually or audibly or in printed means for presenting a selection of information, identification images and drug, alcohol and health analysis results received from said central facility controller.

2. A system as defined in claim 1, said fuzzy logic algorithms can analyze, frame by frame, the video of the movement of said subject or subjects contained in the said video data by isolating the subject from the background and implementing a set of control points on the image that describe the movement and implementing a grid segmentation on the image with which the said fuzzy logic algorithms can develop electronic or mathematical and matrix derived signatures in the time domain that represent and describe the movement of said subject being viewed and can store said signatures in databases.

3. A system as defined in claim 1, said fuzzy logic algorithms can access said related databases of information to derive standard calibrated information defining intoxicated, impaired, encumbered appearance and movement of subjects due to alcohol, drug or health influences on the body for comparison to real time or recorded information derived from subsequent said observed audio and video data of subjects.

4. A system as defined in claim 2, said fuzzy logic algorithms can derive said signatures from video data of normal non-intoxicated non-impaired, healthy subjects to establish databases of the signatures of calibrated standard normal movement, appearance and health of subjects.

5. A system as defined in claims 1, 2, 3, and 4, in which the said fuzzy logic algorithms can detect and measure the stress on the subject resulting in sweating on the face of said subject as a potential indication of intoxication, impairment, encumbrance or health problem by comparison to said databases.

6. A system as defined in claims 1, 2, 3, and 4, in which the said fuzzy logic algorithms can detect and measure the stress on the subject resulting in dilation of the pupils of the eyes of said subject as a potential indication of intoxication, impairment, encumbrance or health problem by comparison to said databases.

7. A system as defined in claims 1, 2, 3, and 4, in which the said fuzzy logic algorithms can detect and measure the stress on the subject resulting in discoloration, such as reddening, of the white of the eye of said subject as a potential indication of intoxication, impairment, encumbrance or health problem by comparison to said databases.

8. A system as defined in claims 1, 2, 3, and 4, in which the said fuzzy logic algorithms can detect and measure the stress on the subject resulting in discoloration on the face, such as blushing or flushing, of said subject as a potential indication of intoxication, impairment, encumbrance or health problem by comparison to said databases.

9. A system as defined in claims 1, 2, 3, and 4, in which the said fuzzy logic algorithms can detect and measure the stress on the subject resulting in movement of leaning on an object for physical support, such as a wall, by said subject as a potential indication of intoxication, impairment, encumbrance or health problem by comparison to said databases.

10. A system as defined in claims 1, 2, 3, and 4, in which the said fuzzy logic algorithms can detect and measure the stress on the subject resulting in movement of threatening motion, such as throwing or hitting or punching, or chopping, by said subject as a potential indication of intoxication, impairment, encumbrance or health problem by comparison to said databases.

11. A system as defined in claims 1, 2, 3, and 4, in which the said fuzzy logic algorithms can detect and measure the stress on the subject resulting in movement of confronting another person, such as by face to face arguing, by said subject as a potential indication of intoxication, impairment, encumbrance or health problem by comparison to said databases.

12. A system as defined in claims 1, 2, 3, and 4, in which the said fuzzy logic algorithms can detect and measure the stress on the subject resulting in movement of molesting another person, such as by groping, by said subject as a potential indication of intoxication, impairment, encumbrance or health problem by comparison to said databases.

13. A system as defined in claims 1, 2, 3, and 4, in which the said fuzzy logic algorithms can detect and measure the stress on the subject resulting in movement, such as gait, staggering or falling, by said subject as a potential indication of intoxication, impairment, encumbrance or health problem by comparison to said databases.

14. A system as defined in claims 1, 2, 3, and 4, in which the said fuzzy logic algorithms can detect and measure the stress on the subject resulting in movement to near another person, such as by back to back passing of an item or package, by said subject as a potential indication of drug dealing as a potential indication of existing or pending intoxication, impairment, encumbrance or health problem by comparison to said databases.

15. A system as defined in claims 1, 2, 3, and 4, in which the said fuzzy logic algorithms can compare signatures derived from video data of the movement of a subject in general, with those of calibrated normal movement signatures and other such information stored in the said databases from which the said fuzzy logic algorithms can analyze the deviation of the movement of said subject in general from normal movement and can display the deviation graphically or numerically on said output device.

16. A system as defined in claim 1, 2, 3, and 4, in which the said fuzzy logic algorithms can superimpose on the said video images of the movement of any subject in general, coloration representing the deviation of the movement of the said subject in general from the said calibrated standard normal movement by coloring, say red, and say from the bottom of the image upwards, that percentage of the image equivalent to the percentage the movement of the subject in general deviates from the normal movement and leaving the remainder of the image in another color, say green, and displaying these on said output device can thereby give the viewer of the video so colored, an instant frame by frame representation of the degree of deviation.

17. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyze deviation of the said subjects in general signatures and information from these said calibrated signatures and information to interpret the degree of intoxication, impairment, encumbrance or health problem of the said subjects in general.

18. A system as defined in claims 1, 2, 3, and 4, in which the said fuzzy logic algorithms can compile databases of ranges of signatures the said fuzzy logic algorithms derive from video of the movement of subjects ranging from those defined as calibrated normal signatures through signatures from subjects with increasing degrees of intoxication, or impairment, or encumbrance, due to increasing levels of alcohol or drug use or health problems and other such information stored in the said databases, such that these compiled databases can form a set of calibration databases we call “Visual Response Measure” as a standard, deviation from which the said signatures and information of said subjects in general can permit the said fuzzy logic algorithms to interpret the degree or level of intoxication, impairment, encumbrance or health problem of the said subjects in general.

19. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information to establish and monitor time dependant changes in the movement of said subjects in general.

20. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information to establish and monitor time dependant changes in the movement of said subjects in general with which the said fuzzy logic algorithms can learn of the changing from which the said fuzzy logic algorithms can decide the changes may require further video monitoring of the subject.

21. A system as defined in claims 1, 2, 3, and 4, in which the said fuzzy logic algorithms can compare signatures the said fuzzy logic algorithms along with neural networks and other artificial intelligence means can derive from said subjects in general with those of the calibrated normal signatures and other such information stored in the said databases, and said analyzed deviation of the said subjects in general signatures and information from these said calibrated signatures and information to establish and monitor the time-dependant changes in the movement of said subjects in general with subsequent signature deviations from subsequent video data which the said fuzzy logic algorithms can learn of the changing with time from which the said fuzzy logic algorithms can decide the changes are an indication the said subject appears to be approaching intoxication, impairment, encumbrance or health problems that warrant said fuzzy logic algorithms to activate notice to appropriate security personnel for investigation and response.

22. A system as defined in claims 1, 2, 3, and 4, in which the said fuzzy logic algorithms using neural networks and artificial intelligence can analyze and interpret the signatures of said subjects for calibrations of what the said system will recognize as normal signatures such that signatures and information of said subjects in general can be analyzed for deviations away from said normal such as by detecting the appearance or actions of persons or animals or things that are or could be threatening; or such as presence of persons or animals or things that should not be present in locations being observed; or such as actions of persons or animals or things that are violent or vandalizing.

23. A system as defined in claims 1, 2, 3, and 4, in which the said fuzzy logic algorithms using neural networks and artificial intelligence can analyze and interpret the signatures of said subjects for calibrations of what the said system will recognize as normal signatures such that signatures and information of said subjects in general can be analyzed for deviations away from said normal by detecting the stress or distress of persons or animals such as from eye movements like darting; or such as from body movements like agitated fidgeting and hand or feet shuffling and pointing or threatening; or such as from detecting facial forehead flushing and thermal warm areas indicating increased blood flow in the frontal vessels of the forehead; or such as from nervousness causing perspiration; or such as emotional verbal outbursts or swearing.

24. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or actions of persons or animals to assess the stressful condition of said persons or animals so that if the said stressful condition surpasses a previously determined threshold the said system notifies appropriate security systems or personnel for appropriate action to be taken.

25. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in occurrences where the public gathers such as in transportation terminals of airports, train stations, buses depots, ship ports or in meeting places such as entertainment facilities, sports arenas, public buildings, financial, legal and court facilities in which said signatures and information can be analyzed for deviations away from said normal such as by detecting the appearance or actions of persons to assess the stressful condition of said persons so that if the said stressful condition surpasses a previously determined threshold the said system notifies appropriate security systems or personnel for appropriate action to be taken.

26. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons or animals or things that are or could be threatening; or such as detecting the presence of persons or animals or things that should not be present in locations being observed; or such as detecting the actions of persons, or animals or things that are violent or vandalizing; or such as detecting the actions of persons or animals that are in stress or in distress such as drunken or health/seizure or accident conditions; or such as detecting the said subjects raising a weapon like a gun, knife, club, or missile launcher for which is such actions or stress is detected and such condition surpasses a previously determined threshold the said system notifies appropriate security systems or personnel for appropriate action to be taken.

27. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of said subjects that are or could be threatening or violent, for the purpose of preventing said appearance or actions from escalating into actual violence such as in cases of home invasion; or such as in cases of seniors homes and residences that might use unnecessary restraints or disruptive scheduling of services or activities like mealtimes or exercises.

28. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons that are or could be fraudulent, for the purpose of preventing said appearance or actions from escalating into actual fraud or theft such as in cases of said subjects using cash registers, inventory systems or shipping/storage systems resulting in losses of money or things often referred to as leakage or shrinkage.

29. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the stress or change in appearance or detecting stress or change in the facial recognition or detecting the actions of persons that are or could be dangerous to themselves or others such as actions of persons that are in stress or in distress such as intoxicated or under drug influence that could cause accidents or related conditions in applications such as manufacturing, assembly lines and automated processes.

30. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from the signatures with which the said system has been calibrated to recognize as normal.

31. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information to establish the degree to which the signatures of the said subjects in general deviate from said normal to indicate health-related problems or potential problems for senior citizens such as falling or staggering or the lack of movement in said seniors homes or in private apartments and homes where seniors are living on their own.

32. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate health-related problems or potential problems for senior citizens such as falling or staggering or seizures/heart attacks in hallways of seniors homes, apartment buildings and homes where seniors are living on their own.

33. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate mistreatment or potential related problems for senior citizens such as in private care, or seniors homes, or caregiver environments.

34. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate health-related problems or potential problems for patients such as in health clinics, or in hospitals, or doctors offices.

35. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate health related problems, accidents or potential problems for the general public in public accessible places such as shopping malls, public buildings, transportation facilities such as bus, train, boat or aeroplane terminals.

36. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate alcohol or drug abuse and related problems or potential problems of observed subjects in entertainment facilities such as bars, nightclubs, restaurants, concert venues and theaters.

37. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate alcohol or drug abuse and related problems or potential problems of observed subjects in sales outlets for alcohol products such as in liquor and beer stores, supermarkets, corner stores or where ever alcoholic beverages are sold.

38. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate alcohol or drug abuse and related problems or potential problems of observed subjects in sports facilities such as arenas, ballparks, golf clubs, tennis and basketball courts, hockey rinks, lacrosse and football fields, private and corporate-sponsored boxes as well as specifically in the hallways of such venues.

39. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate threatening or violent actions including pointing of weapons, throwing of projectiles, hitting or striking of persons, and related problems or potential problems of observed subjects in public or private facilities whether indoors or out-of-doors such as sporting events, conventions, churches, and entertainment venues.

40. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate threatening or violent actions including pointing of weapons, throwing of projectiles, hitting or striking of persons, and related problems or potential problems of observed subjects, or objects such as bombs, suspicious packages, brief cases, bags, boxes, knapsacks and the like left unattended in government facilities such as in court and judicial facilities, and such as at border security areas or points of entry to places or countries and such as in shipping ports, terminals, warehouses and docks.

41. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the signatures and information of the said subjects in general from these said calibrated signatures and information can be used to establish the degree to which the signatures of the said subjects in general deviate from said normal to indicate threatening or violent actions including pointing of weapons, throwing of projectiles, hitting or striking of persons, and related problems or potential problems of observed subjects in public facilities such as in travel facilities for bus, train, air or boat terminals.

42. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons that are or could be a threat or potential threat to staff and students in schools, colleges, universities, and daycare and nursery schools.

43. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons that are or could be a threat to security of the homes of the public and which detection assists with the recognition of those perpetrating such threats.

44. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons that are or could be a threat to security of the offices or places of work of the public and which detection assists with the recognition of those perpetrating such threats.

45. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons that are or could be a threat to security of financial institutions such as banks and which detection assists with the recognition of those perpetrating such threats.

46. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or presence of persons, animals, objects or things such as bombs and packages that are or could be a threat to security of financial institutions such as banks which detection assists with the recognition of those persons, objects or things perpetrating such threats.

47. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance, or detecting the facial recognition or detecting the actions of persons that are or could be a security breach or theft potential in places of work such as cashiers and persons handling money or monetary transactions and which detection assists with the recognition of those perpetrating such thefts or potential thefts such as detecting subjects forced to hold their “hands up”.

48. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or detecting the facial recognition or detecting the actions of persons that are or could be a threat to security of the traveling public such as in buses, cars, trains, boats, airplanes, and taxis and which detection assists with the recognition of those perpetrating such threats.

49. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons who are or could be smoking including the motions of smoking, the presence of flame or heat from lighting an item to be smoked such as a cigarette, pipe, cigar, or the presence or heat of the burning glow from said smoked item for the purpose of preventing or stopping said smoking of said item where such is prohibited or unwanted or inappropriate.

50. A system as defined in claims 1, 2, 3, and 4, in which the said fuzzy logic algorithms using neural networks and artificial intelligence can analyze and interpret the signatures of said subjects for calibrations of what the said system will recognize as normal signatures such that signatures and information of said subjects in general can be analyzed for deviations away from said normal such as by detecting the presence of persons or animals or things that should not be present in locations being observed such as a child appearing in an unauthorized place such as a construction site or a swimming pool, or an underage person appearing in an age-restricted place like a bar or nightclub.

51. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons in public facilities who are or could be carrying an alcoholic drink or drinking such in a prohibited area such as at a place of work, or on a street, or such as outside an approved or licensed drinking area such as in a bar, nightclub, auditorium, or entertainment venue for which said detection can be transmitted by wire or wireless communications to the security personnel or systems of said facilities to take appropriate action.

52. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons who are or could be under the influence of alcohol such as by analyses of the walking gait or stagger of subjects under police roadside safety checks of drivers, such as the R.I.D.E. program for which said analyses could detect said influence and could measure the degree of said influence and could record said stagger along with facial detection and facial recognition and could transmit said recording via wireless communications to police facilities, personnel or systems for appropriate action to be taken.

53. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons in a public or private facility, who are or could be placing something in a persons drink such as a “date rape drug” when that person may not notice, such as occurring at a bar or nightclub for which said detection can be transmitted by wire or wireless communications to the security personnel or systems of said facility to take appropriate action such as to check the said drink and take follow-up actions as needed.

54. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons in a industrial situation such as to cause a hazardous condition such as leaving hot material near combustible items or wet material near electrical systems, or such as to cause a health threat or injury to people such as leaving open containers of chemicals, or such as actions by people themselves to cause personal injury such as detecting said people attempting to lift items incorrectly by hand and possibly causing back injury or lifting items by machine in a dangerous manner to themselves or others.

55. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons in a sales, retail or wholesale environment such as a store, shop or warehouse for which such actions could be interpreted as shoplifting or theft of items, which said analyses and detection could be transmitted wired or wirelessly to security personnel or systems for appropriate actions to be taken.

56. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons who are or could be under the influence of alcohol such as by said analyses of the walking gait or stagger of said subjects and for which said signatures could include the use of a pressure-sensitive mat which could be connected to the said system from which additional data could be observed to assist detection and analyses of the cadence and signature gait of said subjects which could be detected and measured for use both as a measure of potential alcohol influence or impairment of said subject's walking as well as said cadence being used as a unique “walk-print” identifier of said subject similar to the unique fingerprint each person possesses.

57. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons who are or could be under the influence of alcohol such as by said analyses of the walking gait or stagger of said subjects and for which said signatures could include the use of a pressure-sensitive mat which could be connected to the said system from which additional data could be observed to assist detection and analyses of the cadence and signature gait of said subjects which could be detected and measured for use both as a measure of the presence of a subject in a restricted or supervised area or place such as a burglar invading a home, private, commercial or government property or a worker moving in a dangerous environment such as robotic manufacturing, heavy equipment mining, biomedical containment laboratories, or for detecting the impairment of said subject's walking or movements such as subjects such as seniors living alone and suffering heart attack, stroke, falls and if used on stairs for detecting stumbling or falling, as well as said mat permitting the detection of a said presence or movement and said detection being used as a trigger for the said system to record video and audio surveillance of said area or place such as a person or animal entering a swimming pool area without permission or supervision or a person attempting to leave a said area or place from which they are not permitted to leave such as seniors wandering away from a health-care facility or inmates from a prison.

58. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the stress on said subject from detecting the appearance or the actions of a person's face such as to detect said subject's face as being unique or such as detecting facial sweating, blushing, eyes or facial muscle twitching, eye pupils dilated or constricted, and which said system could record that subject's face and stress from which a facial database could be created and with which known facial recognition analyses could be applied to determine the identity of said subject and with which said detected face, condition and stress could be related to actions of said subject and recorded in said database.

59. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of a person's face such as to detect said subject's face as being unique and which said system could record that subject's face from which a facial database could be created and with which known facial recognition analyses could be applied to determine the identity of said subject and with which said detected face could be related to actions of said subject and recorded in said database.

60. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of a person's face such as to detect said subject's face as being unique and which said system could record that subject's face from which a facial database could be created and with which known facial recognition analyses could be applied to determine the identity of said subject and with which said detected face could be related to actions of said subject and recorded in said database and said database could be shared with others via networked linkages such as LANs or wired or wireless networks such as the Internet.

61. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons which said system could record in a database said actions or appearance of said subjects and said database could be shared with others via networked linkages such as LANs or wired or wireless networks such as the Internet with which such networked linkages could also include transmitting of advertising to market products, services, or information.

62. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said system can analyze deviation of the signatures and information of the said subjects in general from these said calibrated signatures and information which can be used to establish the degree to which the signatures of the said subjects in general deviate from said normal to indicate vandalizing actions such as motions of subjects defacing property such as by detection of use of spray cans for painting graffiti or otherwise defacing public or private property or facilities whether indoors or out-of-doors.

63. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said system can analyze deviation of the signatures and information of the said subjects in general from these said calibrated signatures and information can be used to establish the degree to which the signatures of the said subjects in general deviate from said normal in situations where said subject is a passenger on a transit vehicle such as a car, bus, train, airplane or boat for which said analyses indicates a motion or an action that is or could be a threat to said vehicle or other passengers or operators which said detection of actions and or facial detection of said subjects could be transmitted wired or wirelessly to security personnel or systems on said vehicle or to vehicle control centers or systems or police facilities for appropriate actions.

64. A system as defined in claims 1, 2, 3, and 4, in which the said fuzzy logic algorithms can compare motion signatures of people, animals or things the said fuzzy logic algorithms, neural networks, and other artificial intelligent systems derived from said subjects motion in general with those of the calibrated normal motion signatures and other such information stored in the said databases, and said analyzed deviation of the said signatures and information of the said subjects in general from these said calibrated signatures and information can be used to establish the degree to which the motion signatures of the said subjects in general deviate from said normal in situations in which the said deviation is characteristic of specific actions, threats, behaviors, use of objects by or stress on or by said subjects, which detection can be transmitted to appropriate security authorities to take what ever responsive actions are needed.

65. A system as defined in claims 1, 2, 3, and 4, in which the said fuzzy logic algorithms can compare motion signatures of people, animals or things the said fuzzy logic algorithms, neural networks, and other artificial intelligent systems derived from said subjects motion in general with those of the calibrated normal motion signatures and other such information stored in the said databases, and said analyzed deviation of the said signatures and information of the said subjects in general from these said calibrated signatures and information can be used to establish the degree to which the motion signatures of the said subjects in general deviate from said normal in situations in which the said deviation is characteristic of specific actions, threats, behaviors, use of objects by or stress on or by said subjects, which detection can be add to existing security systems such as those that detect persons in restricted areas such as homes, schools, financial businesses, banks, such as those sensor alarms such as detecting fire, breach of property and places, medical alert, and such as those for access control; such said existing security systems from the ADT Security Services Inc.

66. A system as defined in claims 1, 2, 3, and 4, in which the said fuzzy logic algorithms can compare motion signatures of people, animals or things the said fuzzy logic algorithms, neural networks, and other artificial intelligent systems derived from said subjects motion in general with those of the calibrated normal motion signatures and other such information stored in the said databases, and said analyzed deviation of the said signatures and information of the said subjects in general from these said calibrated signatures and information can be used to establish the degree to which the motion signatures of the said subjects in general deviate from said normal in situations in which the said deviation is characteristic of specific actions, threats, behaviors, use of objects by or stress on or by said subjects, which detection can be add to existing security systems such as surveillance systems that detect burglar intrusions such as in financial businesses and banks, such as sensor alarms that detect fire, medical alert, and such as systems processing photo ID, video surveillance and recording for access control, and such as said security and surveillance systems that are networked by wired, wireless or Internet for monitoring said surveillance systems; such said existing security systems from the CUBB Security Systems.

67. A system as defined in claims 1, 2, 3, and 4, in which the said fuzzy logic algorithms can compare motion signatures of people, the said fuzzy logic algorithms, neural networks, and other artificial intelligent systems derived from said subjects motion in general with those of the calibrated normal motion signatures and other such information stored in the said databases, and said analyzed deviation of the said signatures and information of the said subjects in general from these said calibrated signatures and information can be used to establish the degree to which the motion signatures of the said subjects in general deviate from said normal in situations in which the said deviation is characteristic of specific actions such as viewing subjects parking vehicles in parking areas where said subjects actions do not represent legitimate parking such as said subjects not entering the facilities for which said parking area is used but rather said subject is detected to walk away and for which said system could implement facial detection and recognition and could implement vehicle license plate detection and recognition which detection and recognition information can be transmitted to appropriate security authorities to take what ever responsive actions are needed.

68. A system as defined in claims 1, 2, 3, and 4, in which the said fuzzy logic algorithms can compare motion signatures of people, the said fuzzy logic algorithms, neural networks, and other artificial intelligent systems derived from said subjects motion in general with those of the calibrated normal motion signatures and other such information stored in the said databases, and said analyzed deviation of the said signatures and information of the said subjects in general from these said calibrated signatures and information can be used to establish the degree to which the motion signatures of the said subjects in general deviate from said normal in situations in which the said deviation is characteristic of specific actions such as viewing subjects loading vehicles such as at loading docks such as to detect what items are being loaded and into which vehicles they are being loaded such as for shipments going to security sensitive areas such as border crossings or security restricted sites such as military areas and for which said system could implement facial detection and recognition and could implement vehicle license plate detection and recognition which detection and recognition information can be transmitted to appropriate security authorities to take what ever responsive actions are needed.

69. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information for which these video data have been processed to detect and derive motion analysis comparing video pixels or groups of pixels, frame to frame and first frame to current frame by which to establish which pixels or objects or subjects in the current frame are moving from all other pixels or objects or subjects considered non-moving “background” thereby improving the defined non-moving background analysis and resulting in improving the detected movement of said subjects and said signatures used by said fuzzy logic.

70. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information for which these video data have been processed to detect and derive motion analysis comparing video pixels or groups of pixels, frame to frame and first frame to current frame by which to establish which pixels or objects or subjects in the current frame are moving from all other pixels or objects or subjects considered non-moving “background” thereby improving the defined non-moving background analysis and resulting in improving the detected movement of said subjects and said signatures used by said fuzzy logic to establish and monitor time dependant changes in the movement of said subjects in general.

71. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information for which these video data have been processed to detect and derive motion analysis comparing video pixels or groups of pixels, frame to frame and first frame to current frame by which to establish which pixels or objects or subjects in the current frame are moving from all other pixels or objects or subjects considered non-moving “background” thereby improving the defined non-moving background analysis and resulting in improving the detected movement of said subjects and said signatures used by said fuzzy logic to establish and monitor time dependant changes in the movement of said subjects for the detection of falling.

72. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information for which these video data have been processed to detect and derive motion analysis comparing video pixels or groups of pixels, frame to frame and first frame to current frame by which to establish which pixels or objects or subjects in the current frame are moving from all other pixels or objects or subjects considered non-moving “background” thereby improving the defined non-moving background analysis and resulting in improving the detected movement of said subjects and said signatures used by said fuzzy logic to establish and monitor time dependant changes in the movement of said subjects for the detection of walking gait.

73. A system as defined in claims 1, 2, 3, and 4, in which the said fuzzy logic algorithms can compare signatures the said fuzzy logic algorithms derived from said subjects in general with those of the calibrated normal signatures and other such information stored in the said databases, and said analyzed deviation of the said subjects in general signatures and information from these said calibrated signatures and information for which 2-camera systems have been added to provide stereoscopic video data which are processed to detect and derive motion and depth perception analysis comparing video pixels or groups of pixels, frame to frame and first frame to current frame by which to establish which pixels or objects or subjects in the current frame are moving and fuzzy logic algorithms deriving how far from the camera systems each observed object and subject is situated and how large each is relative to all other pixels or objects or subjects considered non-moving “background” thereby improving the defined non-moving background analysis and resulting in improving the detected movement of said subjects and said signatures used by said fuzzy logic.

74. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance or the actions of persons such as seniors who are or could having difficulty walking such as by said analyses of the walking gait or stagger of said subjects and for which said system could include the use of a pressure-sensitive mat such as located in the subject's bed to signal the subject is getting out of bed and could fall or such as on the floor beside the subject's bed detecting a fall out of bed or such as in an area where the subject would walk and could or does fall which mat data could be connected to the said system from which these additional data could be observed to assist detection and analyses of the subjects motion in falling such as from suffering heart attack, stroke, stumbling for which the said mat permitting the additional detection data of a said falling movement can improve the said fuzzy logic algorithms reliability in detecting and monitoring such falls.

75. A system as defined in claims 1, 2, 3, and 4, in which the said fuzzy logic algorithms can compare signatures the said fuzzy logic algorithms derived from said subject's movement such that the said fuzzy logic algorithms with neural networks and artificial intelligence can analyze and interpret the signatures of said observations of said subject for calibrations of what the said system will recognize as normal signatures such that signatures and information of said subject's in general can be analyzed for deviations away from said normal such as by detecting the appearance or the actions of the subject's walking gait or stagger of said subject with those of the calibrated normal signatures and other such information such as previous walking gait data for the same said subject taken at an earlier time and stored in the said databases, and said analyzed deviation of the said subject's gait signatures and information from these said calibrated signatures and information to establish and monitor time dependent changes in the movement and walking gait of the said subject thereby providing an assessment of the change such as degradation or improvement or no-change in the subject's current gait compared to both a “normal” gait and the subject's earlier gait observed and recorded by said system.

76. A system as defined in claims 1, 2, 3, and 4, in which the said fuzzy logic algorithms can compare signatures the said fuzzy logic algorithms derived from said subject's movement such that the said fuzzy logic algorithms with neural networks and artificial intelligence can analyze and interpret the signatures of said observations of said subject for calibrations of what the said system will recognize as normal signatures such that signatures and information of said subject's in general can be analyzed for deviations away from said normal such as by detecting the appearance or the actions of the subject's walking gait or stagger of said subject with those of the calibrated normal signatures and other such information such as previous walking gait data for the same said subject taken at an earlier time and stored in the said databases, and said analyzed deviation of the said subject's gait signatures and information from these said calibrated signatures and information to establish and monitor time dependant changes in the movement and walking gait of the said subject thereby providing an assessment of the change such as degradation or improvement or no-change in the subject's current gait compared to both a “normal” gait and the subject's earlier gait observed and recorded by said system where in said subject is a senior citizen such as in a senior's residence, or such as in a hospital, or such as in a senior's extended care home.

77. A system as defined in claims 1, 2, 3, and 4, in which the said fuzzy logic algorithms with neural networks and artificial intelligence can analyze and interpret the signatures of said subjects for calibrations of what the said system will recognize as normal signatures such that signatures and information of said subjects in general can be analyzed for deviations away from said normal such as by detecting the appearance of a person's face such as observing said person as they approach a restricted area or such as they approach a controlled or locked entrance door for which observations and said analysis can be used to detect said subject's face as being unique and which said system could record that subject's face from which a facial database could be created and with which known facial recognition analyses could be applied to determine the identity of said subject and could relate the observed face to those already stored faces in said databases of subjects permitted access to the said restricted area or controlled doors by which said system with networked communications could allow entrance to said restricted area or unlocking said doors for those subject's who's faces the system recognizes as permitted access to said restricted areas or doors to which said system has control or said system could report faces of all said observed subjects to proper authorities who have capability and authority to permit access to said areas or open said controlled doors for said authority to consider the said system analysis results of those subjects said system recognized as allowed access and for said authority to weigh their own analysis of subjects that are to be permitted such access for which all faces observed and those allowed access could be recorded in said databases for future reference.

78. A system as defined in claims 1, 2, 3, and 4, in which the said fuzzy logic algorithms can analyze and interpret the signatures of said subjects for calibrations of what the said system will recognize as normal signatures such that signatures and information of said subjects in general can be analyzed for deviations away from said normal where in the said system algorithms and analysis and interpretation is integrated into the said camera such as on in-camera computer chip processors and memory, thus the camera becoming a “smart camera” permitting faster processing analysis and potentially permitting the system to only record the live video data and the processed analysis results when the system detects deviations away from normal outside predetermined limits while being able to communicate any detected potential health related problems of the observed subjects or threat or security breach the said analysis recognizes, to authorities for appropriate response.

79. A system as defined in claims 1, 2, 3, and 4, in which the said fuzzy logic algorithms can analyze and interpret the signatures of said subjects for calibrations of what the said system will recognize as normal signatures such that signatures and information of said subjects in general can be analyzed for deviations away from said normal where in the said system algorithms and analysis and interpretation is integrated into the said camera such as on in-camera computer chip processors and memory, thus the camera becoming a “smart camera” permitting faster processing analysis and potentially permitting the system to only record the processed analysis results when the system detects deviations away from normal outside predetermined limits such that the camera acting as a sensor rather than a video recording system sensor system can process the video data of observed subjects recording only the results of the said analysis specifically preserving the privacy of said subjects by only recording the results of the analysis and the detected appearance, movements, actions and deviations from normal while being able to communicate any detected potential health related problems of the observed subjects or threat or security breach the said analysis recognizes, to authorities for appropriate response.
